(19) United States
(12) Patent Application Publication
(10) Pub. No.: US 2023/0004751 A1
(43) Pub. Date: Jan. 5, 2023

(54) Clustering Method and Apparatus for Spatial Points, and Electronic Device

(71) Applicant: Beijing Baidu Netcom Science Technology Co., Ltd., Beijing (CN)

(72) Inventor: Yanyan LI, Beijing (CN)

(73) Assignee: Beijing Baidu Netcom Science Technology Co., Ltd., Beijing (CN)

(21) Appl. No.: 17/729,326

(22) Filed: Apr. 26, 2022

(30) Foreign Application Priority Data
Jun. 30, 2021 (CN) 202110736169.3

(51) Int. Cl. G06K 9/62

(52) U.S. Cl. CPC G06K 9/6223; G06K 9/6224

(57) ABSTRACT

The present disclosure provides a clustering method and apparatus for spatial points, and an electronic device, relates to the field of artificial intelligence, and in particular, to intelligent transportation. The specific implementation solution includes: clustering multiple spatial points to-be-processed according to distances between the multiple spatial points to-be-processed to obtain multiple first clustering groups; for each first clustering group, determining a first external graph enclosing all the spatial points to-be-processed in this first clustering group; and merging the multiple first clustering groups according to distances between first external graphs of the multiple first clustering groups to obtain at least one second clustering group. Therefore, clustering efficiency can be enhanced.

### TECHNICAL FIELD

The present disclosure relates to the field of artificial intelligence, and in particular to intelligent transportation.

### BACKGROUND

In many application scenarios, spatial points are required to be clustered. For example, in order to reasonably plan the deployment of public services, clustering may be performed according to a position at which each community is located, and the public services are deployed according to clustering results.

### SUMMARY

The present disclosure provides a method and apparatus for enhancing clustering efficiency, a device and a storage medium.

In an embodiment of the present disclosure, a clustering method for spatial points is provided. The method may include the following operations.

Multiple spatial points to-be-processed are clustered according to distances between the multiple spatial points to-be-processed to obtain multiple first clustering groups.

For each first clustering group, a first external graph enclosing all the spatial points to-be-processed in this first clustering group is determined.

Multiple first clustering groups are merged according to distances between first external graphs of the multiple first clustering groups to obtain at least one second clustering group.

In another embodiment of the present disclosure, a clustering apparatus for spatial points is provided. The apparatus may include a first clustering module, a first external graph determination module and a second clustering module.

The first clustering module is configured to cluster multiple spatial points to-be-processed according to distances between the multiple spatial points to-be-processed to obtain multiple first clustering groups.

The first external graph determination module is configured to, for each first clustering group, determine a first external graph enclosing all the spatial points to-be-processed in this first clustering group.

The second clustering module is configured to merge the multiple first clustering groups according to distances between first external graphs of the multiple first clustering groups to obtain at least one second clustering group.

In another embodiment of the present disclosure, an electronic device is provided. The electronic device may include:

at least one processor; and

a memory, in communication connection with the at least one processor.

The memory is configured to store instructions capable of being performed by the at least one processor. The instructions are performed by the at least one processor to perform the method mentioned above.

In another embodiment of the present disclosure, a non-transitory storage medium storing computer instructions is provided. The computer instructions are used for performing the method mentioned above.

In another embodiment of the present disclosure, a computer program product is provided. The computer program product includes a computer program. The method mentioned above is implemented when the computer program is performed by a processor.

It is to be understood that, the content described in this section is not intended to identify the key or important features of the embodiments of the present disclosure, nor is it intended to limit the scope of the present disclosure. Other features of the present disclosure will become easy to understand through the following description.

### BRIEF DESCRIPTION OF THE DRAWINGS

Drawings are used for better understanding the solution, and are not intended to limit the present disclosure.

FIG. 1 is a schematic flowchart of a clustering method for spatial points according to an embodiment of the present disclosure.

FIG. 2 is a schematic flowchart of a method for calculating distances between first external graphs according to an embodiment of the present disclosure.

FIG. 3 is a schematic diagram of a distribution of second external graph and a first external graph according to an embodiment of the present disclosure.

FIG. 4 is another schematic flowchart of a method for calculating distances between first external graphs according to an embodiment of the present disclosure.

FIG. 5 is a schematic structural diagram of a clustering apparatus for spatial points according to an embodiment of the present disclosure.

FIG. 6 is a schematic structural diagram of an electronic device according to an embodiment of the present disclosure.

### DETAILED DESCRIPTION

Exemplary embodiments of the present disclosure are described in detail below with reference to the drawings, including various details of the embodiments of the present disclosure to facilitate understanding, and should be regarded as exemplary. Thus, those of ordinary skilled in the art shall understand that, variations and modifications can be made on the embodiments described herein, without departing from the scope and spirit of the present disclosure. Likewise, for clarity and conciseness, descriptions of well-known functions and structures are omitted in the following description.

In order to describe a clustering method for spatial points provided by an embodiment of the present disclosure more clearly, a possible application scenario of the method for spatial points provided by the present disclosure will be exemplarily described below. It is to be understood that, an example below is the possible application scenario of the method for spatial points provided by an embodiment of the present disclosure. In other optional embodiments, the method for spatial points provided by an embodiment of the present disclosure may also be applicable to other possible application scenarios. The example below does not impose any limitations herein.

In order to characterize roads in an area, multiple spatial points may be selected from at least one road of the area. The selected spatial points are clustered to obtain clustering results, and the at least one road in the area is characterized by utilizing the clustering results. For ease of description, assuming that 100 spatial points are selected from the at least one road of the area, the 100 spatial points are respectively recorded as spatial points 1 to 100.

Each spatial point in the spatial points 1 to 100 may be taken as a clustering group. The following steps are repeatedly performed, until a preset termination condition is reached. Clustering groups reaching the preset termination condition are taken as clustering results of the spatial points 1 to 100.

Step A: For every two clustering groups, a Euclidean distance between one spatial point belonging to one clustering group and another spatial point belonging to the other clustering group is calculated. An average of all calculated Euclidean distances is taken as a between-class distance between the two clustering groups.

Step B: two clustering groups with the smallest between-class distance are merged.

For example, for ease of description, assuming that a clustering group including a spatial point 1 is a clustering group 1, a clustering group including a spatial point 2 is a clustering group 2, and so on, an Euclidean distance between the spatial point 1 and the spatial point 2 may be calculated. Since each clustering group includes one spatial point, the Euclidean distance between the spatial point 1 and the spatial point 2 may be taken as the between-class distance between the clustering group 1 and the clustering group 2.

Assuming that the between-class distance between the clustering group 1 and the clustering group 2 is the smallest, the clustering group 1 and the clustering group 2 may be merged. The merged clustering group is recorded as a clustering group 101. In this case, the clustering groups include clustering groups 3 to 101.

Then, for every two clustering groups in the clustering groups 3 to 101, the Euclidean distance between every two spatial points respectively belonging to the two clustering groups is calculated. The average of all calculated Euclidean distances is taken as the between-class distance between the two clustering groups. The calculation of the between-class distance between the clustering group 3 and the clustering group 101 is taken as an example. Since the clustering group 3 includes the spatial point 3 and the clustering group 101 includes the spatial points 1 and 2, an Euclidean distance (recorded as a first Euclidean distance) between the spatial point 3 and the spatial point 1 and an Euclidean distance (recorded as a second Euclidean distance) between the spatial point 3 and the spatial point 2 may be respectively calculated. The average of the first Euclidean distance and the second Euclidean distance is calculated as the between-class distance between the clustering group 3 and the clustering group 101. Assuming that the between-class distance between the clustering group 3 and a clustering group 4 is the smallest, the clustering group 3 and the clustering group 4 may be merged. The merged clustering group is recorded as a clustering group 102. In this case, the clustering groups include clustering groups 5 to 102.

By analogy, termination is achieved until the smallest between-class distance is greater than a preset threshold value. Assuming that the clustering groups at a time point of termination include clustering groups 103 and 104, the clustering groups 103 and 104 may be taken as clustering results of the spatial points 1 to 100.

However, on the one hand, in this solution, when the clustering groups are merged each time, the Euclidean distances between a large quantity of spatial points are required to be calculated. The between-class distances are calculated according to the Euclidean distances. Clustering and merging are performed according to the between-class distances. In this way, a large calculated quantity is required during the merging of the clustering groups, resulting in low clustering efficiency.

On the other hand, when the between-class distance between the two clustering groups is calculated, the calculated between-class distance is influenced by space distribution of the spatial points included in the two clustering groups. Exemplarily, assuming that the spatial points 1 to 10 are sampled from an entrance A of a complex intersection and the spatial points 11 to 20 are sampled from an entrance B of the complex intersection, further assuming that the spatial points 1 to 10 belong to a clustering group 105 and the spatial points 11 to 20 belong to a clustering group 106, since the spatial points 1 to 20 belong to the same complex intersection, the clustering group 105 and the clustering group 106 should be theoretically merged into the same clustering group. That is to say, the between-class distance between the clustering group 105 and the clustering group 106 should be relatively small.

However, when most of the points in the spatial points 1 to 10 are sampled from a side of the entrance A that is away from the entrance B, and most of the points in the spatial points 11 to 20 are sampled from a side of the entrance B that is away from the entrance A, the foregoing manner of calculating the between-class distance may cause the between-class distance between the clustering group 105 and the clustering group 106 to be excessive large, so that the clustering group 105 and the clustering group 106 are not merged into the same clustering group. That is to say, this solution may be influenced by the space distribution of the spatial points, resulting in low accuracy.

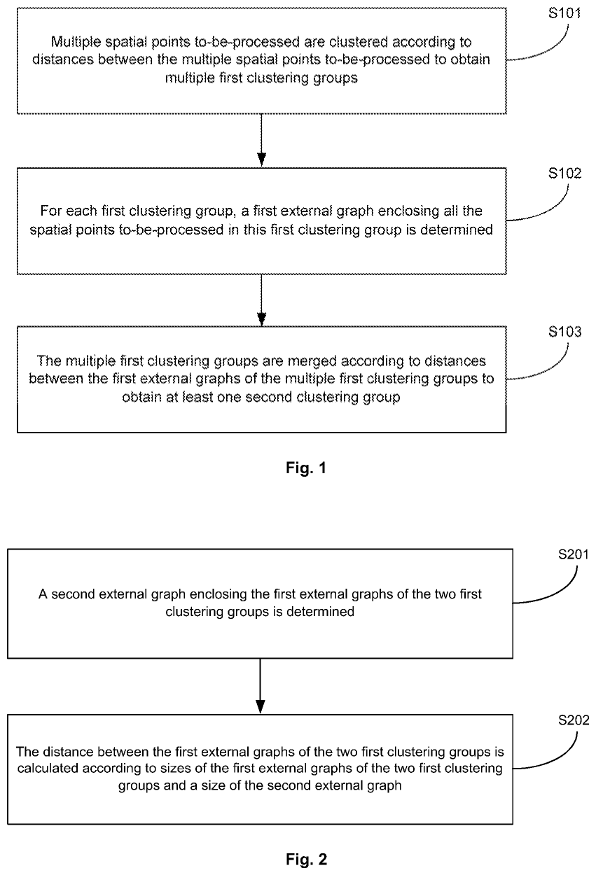

Based on the above, as shown in FIG. 1, FIG. 1 is a schematic flowchart of a clustering method for spatial points according to an embodiment of the present disclosure. The clustering method may include the following steps.

At step S101, multiple spatial points to-be-processed are clustered according to distances between the multiple spatial points to-be-processed to obtain multiple first clustering groups.

At S102, for each first clustering group, a first external graph enclosing all the spatial points to-be-processed in this first clustering group is determined.

At S103, the multiple first clustering groups are merged according to distances between the first external graphs of the multiple first clustering groups to obtain at least one second clustering group.

On the one hand, through this embodiment, positions of the spatial points to-be-processed in the multiple first clustering groups may be generally characterized through the first external graphs, so that distances between the spatial points included in each first clustering group are generally characterized according to the distance between the first external graphs, and the first clustering groups are merged according to the distance between the first external graphs. In addition, since the distance between the first external graphs is taken as the basis of merging the first clustering groups, the calculation of Euclidean distances between the spatial points in the first clustering groups is not required for merging the first clustering groups. In this way, a calculated quantity required by clustering may be effectively reduced, thereby enhancing clustering efficiency.

On the other hand, since the distance between the first external graphs is taken as the basis of merging the first clustering groups, the merging of the first clustering groups may not be influenced by the space distribution of the spatial points to-be-processed in the first external graphs. Therefore, inaccuracy caused by the space distribution of the spatial points may be avoided, that is, the accuracy of clustering may be effectively enhanced.

In the step S101, the spatial points to-be-processed may be positions at which any objects are located. For example, the spatial points to-be-processed may refer to the positions at which entrances of roads are located, may also be the position at which a residential building is located, or may also be the positions at which bus stations are located, which are not limited by the present disclosure. In addition, different spatial points to-be-processed may refer to the positions at which objects of a same type are located, or may also be the positions at which objects of different types are located. For example, a spatial point to-be-processed 1 may refer to the position at which a shopping mall is located, and a spatial point to-be-processed 2 may refer to the position at which a parking lot is located.

By means of at least one clustering manner, the multiple spatial points to-be-processed may be clustered into multiple first clustering groups. Exemplarily, the spatial points to-be-processed may be clustered by using the clustering manner in application scenarios of the foregoing example. The clustering groups included at the end of any cycle are taken as the multiple first clustering groups. Exemplarily, the clustering groups 3-101 in the foregoing example may be taken as the multiple first clustering groups.

The quantity of the spatial points to-be-processed included in each first clustering group may vary according to different application scenarios. It is to be understood that, since the multiple first clustering groups are obtained by clustering the multiple spatial points to-be-processed, at least one first clustering group should include the multiple spatial points. For easy of description hereafter, a case that the first clustering group includes one spatial point to-be-processed or two spatial points to-be-processed will be described. For the case that the first clustering group includes more than two spatial points, a principle is same as that of the case that first clustering group includes two spatial points, so that details are not described again.

In step S102, the first external graph of the first clustering group may refer to a smallest rectangle enclosing all the spatial points to-be-processed in the first clustering group. Exemplarily, assuming that one first clustering group includes two spatial points to-be-processed, and space coordinates of the two spatial points to-be-processed respectively are (x1, y1) and (x2, y2), the first external graph of the first clustering group may refer to the rectangle with (x1, y1), (x1, y2), (x2, y1), and (x2, y2) as vertices. For the clustering group includes one spatial point, the first external graph of the first clustering group may refer to a shape with a preset size and enclosing this one spatial point. Exemplarily, it may be the rectangle with a side length of w and centered on this one spatial point. w may be any real number set according to user experience or actual requirements. In addition, the first external graph may be either a rectangle or a shape other than the rectangle, including but not limited to a circle, a triangle, a trapezoid, a pentagon, a hexagon and the like, which is not limited by the present disclosure.

It is to be understood that, since the first external graph is a shape that encloses all the spatial points to-be-processed in the first clustering group, the first external graph can reflect an area at which the spatial points to-be-processed in the first clustering group are located. The area at which the spatial points to-be-processed are located may generally characterize the positions of the spatial points to-be-processed in the first clustering group. Thus, the first external graph can generally characterize the positions of the spatial points to-be-processed in the first clustering group.

In step S103, the calculation of the distance between the two first external graphs will be described in detail below with examples, so that details are not described again herein. It is to be understood that, as analyzed above, since the first external graph may generally characterize the positions of the spatial points to-be-processed in the first clustering group, the distance between the first external graphs of the two first clustering groups may generally characterize the distance between spatial points to-be-processed of the two first clustering groups. For example, when the first external graphs of the two first clustering groups are far from each other, it may be considered that the two spatial points to-be-processed respectively belonged to the two first clustering groups are generally far from each other. When the first external graphs of the two first clustering groups are close to each other, it may be considered that the two spatial points to-be-processed respectively belonged to the two first clustering groups are generally close to each other.

The manner of merging the first clustering groups according to the distance between the first external graphs may vary according to different application scenarios. Exemplarily, in an optional embodiment, for every two first clustering groups, the distance between the first external graphs of the two first clustering groups is calculated as the between-class distance between the two first clustering groups. The multiple the first clustering groups are merged according to the between-class distance between the two first clustering groups, so that at least one second clustering group is obtained.

Through this embodiment, the distance between the first external graphs is directly used as the between-class distance. Thus, the calculated quantity required by the merging of the first clustering groups can be effectively reduced, thereby further enhancing the clustering efficiency.

In another optional embodiment, the between-class distance between the first clustering groups may be obtained through further processing performed on the distance between the first external graphs. According to the between-class distance between the first clustering groups, the multiple first clustering groups are merged to obtain at least on second clustering groups. Any processing method may be selected according to user experience and/or actual requirements, including but not limited to normalization, correction, rounding and so on.

The method of merging the multiple first clustering groups according to the between-class distance may be the same as the method used for merging the clustering groups in any agglomerative hierarchical clustering. For example, the two first clustering groups between which the between-class distance is the smallest may be merged into one second clustering group. For another example, every two first clustering groups between which between-class distance is less than a preset distance threshold value may also be merged into one second clustering group. Merging may also be performed by using other methods. The present disclosure does not impose any limitations thereto. However, when the first clustering groups are merged, the first clustering groups between which between-class distance is small should be merged into the same second clustering group as much as possible.

After step S103 is performed, the second clustering groups may be taken as clustering results of the spatial points to-be-processed. The second clustering groups may also be continuously merged to obtain third clustering groups. The third clustering groups may be taken as the clustering results of the spatial points to-be-processed. Alternatively, the third clustering groups may be continuously merged to obtain fourth clustering groups, and so on.

Methods for merging the second clustering groups and the third clustering groups may be the same as or different from the method for merging the first clustering groups. For example, the second clustering groups and the third clustering groups may be merged according to the merging method in the application scenarios of the foregoing example.

In order to describe the clustering method for spatial points provided by the present disclosure more clearly, the calculation of the distance between the first external graphs will be exemplarily described below. In an optional embodiment, one point may be randomly selected from each of the two first external graphs. A distance between the selected two points is calculated as the distance between the two first external graphs.

The selected points may vary according to the different application scenarios. Exemplarily, a geometric center of each first external graph may be selected, and alternatively, an intersection point of perpendicular bisectors of any two sides of the first external graph may also be selected. The present disclosure does not impose any limitations thereto. For example, the selected points are geometric centers. Assuming the geometric center of the first external graph A is the geometric center 1 and the geometric center of the first external graph B is the geometric center 2, a distance between the geometric center 1 and the geometric center 2 may be taken as a distance between one first external graph and the other first external graph.

In another optional embodiment, it may also be shown as FIG. 2. FIG. 2 is a schematic flowchart of a method for calculating distances between the first external graphs according to an embodiment of the present disclosure. The method may include the following steps.

At step S201, a second external graph enclosing the first external graphs of the two first clustering groups is determined.

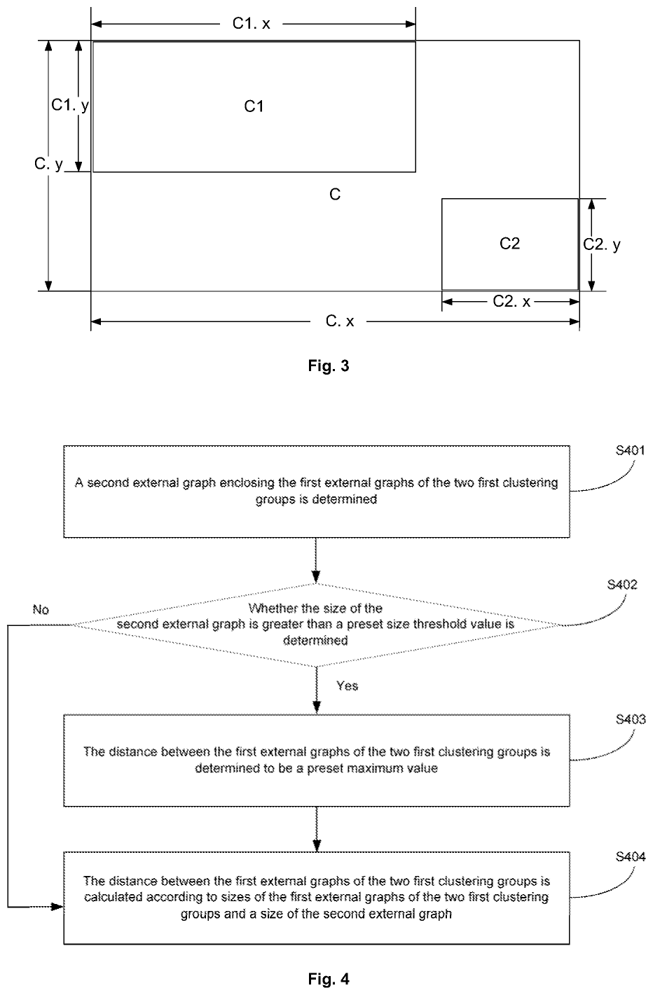

For ease of description, the first external graphs of the two first clustering groups are respectively recorded as C1 and C2. The determined second external graph is recorded as C. It is assumed that C1, C2 and C are smallest external rectangles. Principles for the case that C1, C2 and C are other shapes other than the smallest external rectangles are the same, which are not described again herein. A relationship among C1, C2 and C may be shown in FIG. 3. In an example shown in FIG. 3, in order to clearly shown borders of C1, C2 and C, the borders of C1, C2 and C are shown in anon-overlapping form. It is to be understood that, an upper border and a left border of C1 may be overlapped with the borders of C, and a lower border and a right border of C2 may be overlapped with the borders of C.

At step S202, the distance between the first external graphs of the two first clustering groups is calculated according to sizes of the first external graphs of the two first clustering groups and a size of the second external graph.

The sizes of the external graphs may be shown in different forms according to the different application scenarios. Exemplarily, when the external graphs are circles, the sizes of the external graphs may be shown in any form of radiuses, diameters, perimeters, etc. When the external graphs are polygons, the sizes of the external graphs may be shown in any form of side lengths, perimeters, diagonal lengths, etc.

For ease of description hereafter, a horizontal span and a longitudinal span are taken as an example to indicate the sizes of the external graphs. The same applies to the case that sizes are expressed in other forms, which is not described again herein. The horizontal span represents a difference value between the maximum horizontal coordinate and the minimum horizontal coordinate of the points in the external graphs. The longitudinal span represents a difference value between the maximum longitudinal coordinate and the minimum longitudinal coordinate of the points in the external graphs.

Exemplarily, assuming that one external graph is a rectangle with (x1, y1), (x1, y2), (x2, y1), and (x2, y2) as vertices, with x1<x2, and y 1<y2, the maximum horizontal coordinate of the points in the external graph is x2, the minimum horizontal coordinate is x1, the maximum longitudinal coordinate is y2, and the minimum longitudinal coordinate is y1. Thus, the horizontal span of the external graph is x2−x1, and the longitudinal span is y2−y1.

It is to be understood that, when the size of the respective first external graph of the two first clustering groups remains unchanged, theoretically, the farther the distance between the first external graphs of the two first clustering groups, the larger the size of the second external graph. In addition, when the distance between the first external graphs of the two first clustering groups remains unchanged, the larger the size of the respective first external graph of the two first clustering groups, the larger the size of the second external graph. It may be learned from that, on the one hand, the size of the second external graph depends on the size of the respective first external graph of the two first clustering groups. On the other hand, the size of the second external graph depends on the distance between the first external graphs of the two first clustering groups. Therefore, according to the size of the second external graph and the sizes of the first external graphs of the two first clustering groups, the distance between the first external graphs of the two first clustering groups may be determined.

Through this embodiment, the distance between the two first clustering groups may be accurately calculated according to the size of the second external graph and the sizes of the first external graphs of the two first clustering groups, so as to further enhance the accuracy of clustering.

The method of calculating the distance between the two first external graphs according to the size of the second external graph and the sizes of the first external graphs of the two first clustering groups may vary according to different application scenarios. As analyzed above, since, on the one hand, the size of the second external graph depends on the size of the respective first external graph of the two first clustering groups, and on the other hand, the size of the second external graph depends on the distance between the first external graphs of the two first clustering groups. Therefore, in an optional embodiment, the distance between the first external graphs of the two first clustering groups may be obtained by subtracting the sizes of the first external graph of the two first clustering groups from the size of the second external graph.

In another optional embodiment, a difference value between the size of the second external graph and the size of the large-size first external graph is calculated as the distance between the first external graphs of the two first clustering groups. The large-size first external graph is the first external graph with a large size in the first external graphs of the two first clustering groups.

The sizes may refer to relevant description in the foregoing step S202, which are not described again herein. By taking the sizes shown in the form of the horizontal span and the longitudinal span as an example, it is assumed that the two first clustering groups respectively are the first clustering group A and the first clustering group B, the first external graph of the first clustering group A is recorded as C1, the first external graph of the first clustering group B is recorded as C2, and the second external graph is recorded as C. And it is further assumed that, as shown in FIG. 3, the horizontal span of C1 is C1.x, the longitudinal span of C1 is C1.y, the horizontal span of C2 is C2.x, the longitudinal span of C2 is C2.y, the horizontal span of C is C.x, and the longitudinal span of C is C.y.

When C1.x+C1.y>C2.x+C2.y, the large-size first external graph is C1, so that a difference value between the size of C and the size of C1 may be calculated as the distance between C1 and C2. That is, the distance between C1 and C2 is (C.x−C1.x)+(C.y−C1.y).

When C1.x+C1.y<C2.x+C2.y, the large-size first external graph is C2, so that a difference value between the size of C and the size of C2 may be calculated as the distance between C1 and C2. That is, the distance between C1 and C2 is (C.x−C2.x)+(C.y−C2.y).

When C1.x+C1.y=C2.x+C2.y, since (C.x−C1.x)+(C.y−C1.y) equals to (C.x−C2.x)+(C.y−C2.y), C1 may be taken as the first external graph, and C2 may also be taken as the first external graph. The calculated distance between C1 and C2 is equal.

Through this embodiment, the difference value between the sizes of the second external graph and the large-size first external graph is used as a distance between the two external graphs. Thus, the distance between the first external graphs may be calculated in a relatively simple manner, so that the clustering efficiency can be further enhanced.

In another optional embodiment, a difference value between the size of the second external graph and the size of the small-size first external graph may also be calculated as the distance between the first external graphs of the two first clustering groups. The small-size first external graph is the first external graph with a small size in the first external graphs of the two first clustering groups.

As shown in FIG. 4, FIG. 4 is another schematic flowchart of a method for calculating distances between first external graphs according to an embodiment of the present disclosure. The method may include the following steps.

At step S401, a second external graph enclosing the first external graphs of the two first clustering groups is determined.

This step is the same as the foregoing S201, which may refer to relevant description in the foregoing S201, and is not described again herein.

At step S402, whether the size of the second external graph is greater than a preset size threshold value is determined. In response to determining that the size of the second external graph is greater than the preset size threshold value, S403 is performed. In response to determining that the size of the second external graph is not greater than the preset size threshold value, S404 is performed.

By taking the sizes shown in the form of a horizontal span and a longitudinal span as an example, the size of the second external graph is greater than the preset size threshold value includes that the horizontal span of the second external graph is greater than a preset horizontal span threshold value and the longitudinal span of the second external graph is greater than a preset longitudinal span threshold value, or the horizontal span of the second external graph is greater than a preset horizontal span threshold value, or the longitudinal span of the second external graph is greater than a preset longitudinal span threshold value, and may also mean that the sum of the horizontal span and the longitudinal span of the second external graph is greater than a preset total span threshold value.

Exemplarily, assuming that the horizontal span of the second external graph is C.x and the longitudinal span is C.y, the size of the second external graph is greater than the preset size threshold value, which may mean that any of the following conditions is met.

Condition 1: C.x>Thx && C.y>Thy

Condition 2: C.y>Thy∥C.y>Thy

Condition 3: C.x+C.y>Thtot

“&&” represents logical operation and. “∥”represents logical operation or. Thx represents the preset horizontal span threshold value. Thy represents the preset longitudinal span threshold value. Thtot represents the preset total span threshold value. Thx may equal to or unequal to Thy.

At step S403, the distance between the first external graphs of the two first clustering groups is determined to be a preset maximum value.

The preset maximum value is greater than the calculated distance between the first external graphs of any two first clustering groups. Exemplarily, the preset maximum value may be positive infinity, and may also be a relatively large value set according to user experience and/or actual requirements. For example, when a user thinks that the distance between the first external graphs of the two first clustering groups exceeds 1000, the two first clustering groups cannot be merged into the same second clustering group. Then, the preset maximum value may be set to 1000.

It is to be understood that, when the size of the second external graph is too large, it may be considered that the distance between the first external graphs of the two first clustering groups is too large. Even if the distance between the first external graphs of the two first clustering groups is calculated, the two first clustering groups cannot be merged into the same second clustering group. Thus, the distance between the first external graphs of the two first clustering groups may be set to a relatively large value to avoid the two first clustering groups from being merged into the same second clustering group, without further calculating the distance between the first external graphs of the two first clustering groups.

At step S404, the distance between the first external graphs of the two first clustering groups is calculated according to sizes of the first external graphs of the two first clustering groups and a size of the second external graph.

This step is the same as the foregoing S202, which may refer to relevant description in the foregoing S202, and is not described again herein.

Through this embodiment, when the size of the second external graph is too large, the distance between the first external graphs of the first clustering groups may be directly set to the preset maximum value. Therefore, the calculated quantity required by the determination of the distance between the first external graphs is saved without influencing the merging of the first clustering groups, so as to further enhance the clustering efficiency.

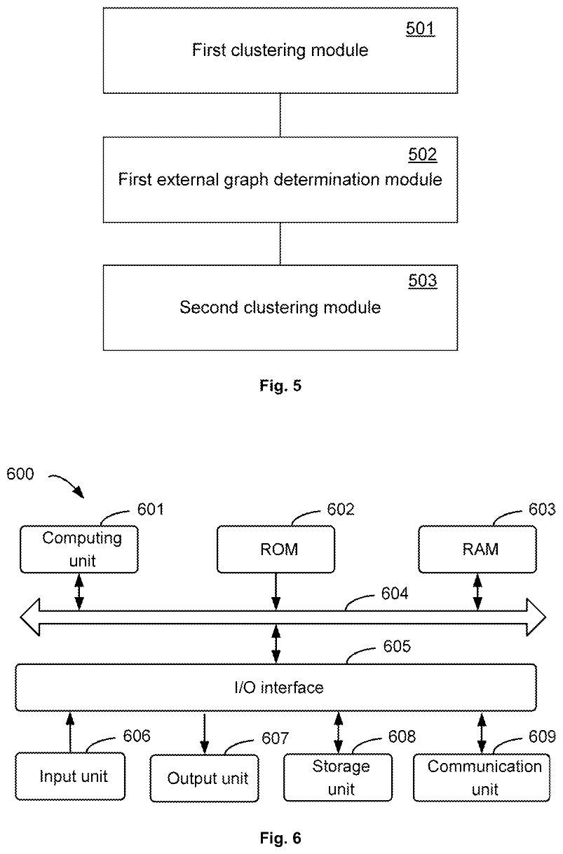

As shown in FIG. 5, FIG. 5 is a schematic structural diagram of a clustering apparatus for spatial points according to an embodiment of the present disclosure. The clustering apparatus may include a first clustering module, a first external graph determination module and a second clustering module.

The first clustering module 501 is configured to cluster multiple spatial points to-be-processed according to distances between the multiple spatial points to-be-processed to obtain multiple first clustering groups.

The first external graph determination module 502 is configured to, for each first clustering group, determine a first external graph enclosing all the spatial points to-be-processed in this first clustering group.

The second clustering module 503 is configured to merge the multiple first clustering groups according to distances between the first external graphs of the multiple first clustering groups to obtain at least one second clustering group.

On the one hand, through this embodiment, positions of the spatial points to-be-processed in the first clustering groups may be generally characterized through the first external graphs, so that distances between the spatial points included in each first clustering group are generally characterized according to the distance between the first external graphs, and the first clustering groups are merged according to the distance between the first external graphs. In addition, since the distance between the first external graphs is taken as the basis of merging the first clustering groups, the calculation of Euclidean distances between the spatial points in the first clustering groups is not required for merging the first clustering groups. In this way, a calculated quantity required by clustering may be effectively reduced, thereby enhancing clustering efficiency.

On the other hand, since the distance between the first external graphs is taken as the basis of merging the first clustering groups, the merging of the first clustering groups may not be influenced by the space distribution of the spatial points to-be-processed in the first external graphs. Therefore, inaccuracy caused by the space distribution of the spatial points may be avoided, that is, the accuracy of clustering may be effectively enhanced.

In an optional embodiment, an operation that the second clustering module 503 merges the multiple first clustering groups according to the distances between the first external graphs of the multiple first clustering groups to obtain the at least one second clustering group includes the following steps.

For every two first clustering groups, distances between the first external graphs of the two first clustering groups is calculated as a between-class distance between the two first clustering groups.

The multiple first clustering groups are merged according to the between-class distance between the two first clustering groups to obtain the at least one second clustering group.

In an optional embodiment, an operation that the second clustering module 503 calculates the distance between the first external graphs of the two first clustering groups as the between-class distance between the two first clustering groups includes the following steps.

A second external graph enclosing the first external graphs of the two first clustering groups is determined.

The distance between the first external graphs of the two first clustering groups is calculated according to sizes of the first external graphs of the two first clustering groups and a size of the second external graph.

In a optional embodiment, an operation that the second clustering module 503 calculates the distance between the first external graphs of the two first clustering groups according to the sizes of the first external graphs of the two first clustering groups and the size of the second external graph includes the following step.

A difference value between the size of the second external graph and the size of a large-size first external graph is calculated as the distance between the first external graphs of the two first clustering groups. The large-size first external graph is a first external graph with a large size in the first external graphs of the two first clustering groups.

In a optional embodiment, the second clustering module 503 is further configured to determine whether the size of the second external graph is greater than a preset size threshold value.

In response to determining that the size of the second external graph is greater than the preset size threshold value, the distance between the first external graphs of the two first clustering groups is determined to be a preset maximum value. The preset maximum value is greater than the calculated distance between the first external graphs of any two first clustering groups.

In response to determining that the size of the second external graph is not greater than the preset size threshold value, the step of calculating the distance between the first external graphs of the two first clustering groups according to the sizes of the first external graphs of the two first clustering groups and the size of the second external graph is performed.

In the technical solution of the present disclosure, the involved acquisition, storage, and application of personal information of a user are in compliance with relevant laws and regulations, and do not violate public order and good customs.

According to an embodiment of the present disclosure, the present disclosure further provides an electronic device, a non-transitory storage medium, and a computer program product.

FIG. 6 is a schematic block diagram of an example electronic device 600 configured to implement an embodiment of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processing, cellular phones, smart phones, wearable devices, and other similar computing devices. The components shown herein, connections and relationships of the components, and functions of the components are merely examples, and are not intended to limit the implementation of the present disclosure described and/or required herein.

As shown in FIG. 6, the device 600 includes a computing unit 601. The computing unit may perform various appropriate actions and processing operations according to a computer program stored in a Read-Only Memory (ROM) 602 or a computer program loaded from a storage unit 608 into a Random Access Memory (RAM) 603. In the RAM 603, various programs and data required for the operation of the device 600 may also be stored. The computing unit 601, the ROM 602, and the RAM 603 are connected with each other by using a bus 604. An Input/Output (I/O) interface 605 is also connected with the bus 604.

Multiple components in the device 600 are connected with the I/O interface 605, and include: an input unit 606, such as a keyboard and a mouse; an output unit 607, such as various types of displays and loudspeakers; the storage unit 608, such as a disk and an optical disc; and a communication unit 609, such as a network card, a modem, and a wireless communication transceiver. The communication unit 609 allows the device 600 to exchange information/data with other devices through a computer network, such as the Internet, and/or various telecommunication networks.

The computing unit 601 may be various general and/or special processing assemblies with processing and computing capabilities. Some examples of computing unit 601 include, but are not limited to, a Central Processing Unit (CPU), a Graphics Processing Unit (GPU), various dedicated Artificial Intelligence (AI) computing chips, various computing units for running machine learning model algorithms, a Digital Signal Processor (DSP), and any appropriate processors, controllers, microcontrollers, etc. The computing unit 601 performs the various methods and processing operations described above, for example, the clustering method for spatial points. For example, in some embodiments, the clustering method for spatial points may be implemented as a computer software program, which is tangibly included in a machine-readable medium, such as the storage unit 608. In some embodiments, part or all of the computer programs may be loaded and/or installed on the device 600 via the ROM 602 and/or the communication unit 609. When the computer program is loaded into the RAM 603 and performed by the computing unit 601, at least one step of the clustering method for spatial points described above may be performed. Alternatively, in other embodiments, the computing unit 601 may be configured to perform the clustering method for spatial points in any other suitable manners (for example, by means of firmware).

The various implementations of systems and technologies described herein may be implemented in a digital electronic circuit system, an integrated circuit system, a Field Programmable Gate Array (FPGA), an Application-Specific Integrated Circuit (ASIC), an Application-Specific Standard Product (ASSP), a System-On-Chip (SOC), a Complex Programmable Logic Device (CPLD), computer hardware, firmware, software, and/or a combination thereof. These various implementations may include: being implemented in at least one computer program, the at least one computer program may be performed and/or interpreted on a programmable system including at least one programmable processor. The programmable processor may be a dedicated or general programmable processor, which can receive data and instructions from a storage system, at least one input device, and at least one output device, and transmit the data and instructions to the storage system, the at least one input device, and the at least one output device.

Program codes used for implementing the method of the present disclosure can be written in any combination of at least one programming language. These program codes can be provided to the processors or controllers of general computers, special computers, or other programmable data processing devices, so that, when the program codes are performed by the processors or controllers, functions/operations specified in the flowcharts and/or block diagrams are implemented. The program codes can be performed entirely on a machine, partially performed on the machine, and partially performed on the machine and partially performed on a remote machine as an independent software package, or entirely performed on the remote machine or a server.

In the context of the present disclosure, a machine-readable medium may be a tangible medium, which may include or store a program for being used by an instruction execution system, device, or apparatus or in combination with the instruction execution system, device, or apparatus. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any foregoing suitable combinations. More specific examples of the machine-readable storage medium may include electrical connections based on at least one wires, a portable computer disk, a hard disk, a RAM, a ROM, an Erasable Programmable Read-Only Memory (EPROM or flash memory), an optical fiber, a portable Compact Disk Read-Only Memory (CD-ROM), an optical storage device, a magnetic storage device, or any above suitable combinations.

In order to provide interaction with a user, the system and technologies described herein can be implemented on a computer, including a display device for displaying information to the user (for example, a Cathode Ray Tube (CRT) or a Liquid Crystal Display (LCD) monitor), a keyboard and a pointing device (for example, a mouse or a trackball). The user can provide an input to the computer by using the keyboard and the pointing device. Other types of devices may also be configured to provide interaction with the user, for example, the feedback provided to the user may be any form of sensory feedback (such as visual feedback, auditory feedback, or tactile feedback), and may be the input from the user received in any form (including acoustic input, voice input, or tactile input).

The system and technologies described herein may be implemented in a computing system (for example, as a data server) including a back-end component, or a computing system (for example, an application server) including a middleware component, or a computing system (for example, a user computer with a graphical user interface or network browser, the user may be in interaction with implementations of the system and technologies described herein by using the graphical user interface or network browser) including a front-end component, or a computing system including any combination of the back-end component, the middleware component, or the front-end component. The components of the system can be connected to each other through any form or digital data communication (for example, a communication network) of the medium. Examples of the communication network include a Local Area Network (LAN), a Wide Area Network (WAN), and the Internet.

The computer system may include a client and a server. The client and the server are generally far away from each other and usually interact by means of the communication network. A relationship between the client and the server is generated by the computer program that is run on the corresponding computer and has a client-server relationship with each other. The server may be a cloud server, and may also be a distributed system server, or a server combined with a blockchain.

It is to be understood that, the steps may be reordered, added or deleted by using various forms of programs shown above. For example, the steps described in the present disclosure may be performed parallelly, sequentially, or in a different order, as long as desired results of the technical solutions disclosed in the present disclosure can be achieved, which are not limited herein.

The foregoing specific implementations do not constitute limitations on the protection scope of the present disclosure. Those skilled in the art should understand that, various modifications, combinations, sub-combinations and substitutions can be made according to design requirements and other factors. Any modifications, equivalent replacements, improvements and the like made within the spirit and principle of the present disclosure shall fall within the scope of protection of the present disclosure.

What is claimed is:

1. A clustering method for spatial points, comprising:
clustering a plurality of spatial points to-be-processed according to distances between the plurality of spatial points to-be-processed to obtain a plurality of first clustering groups;
for each first clustering group, determining a first external graph enclosing all the spatial points to-be-processed in this first clustering group; and
merging the plurality of first clustering groups according to distances between first external graphs of the plurality of first clustering groups to obtain at least one second clustering group.

2. The method as claimed in claim 1, wherein merging the plurality of first clustering groups according to the distances between the first external graphs of the plurality of first clustering groups to obtain the at least one second clustering group comprises:
for every two first clustering groups, calculating distances between the first external graphs of the two first clustering groups as a between-class distance between the two first clustering groups; and
merging the plurality of first clustering groups according to the between-class distance between the two first clustering groups to obtain the at least one second clustering group.

3. The method as claimed in claim 2, wherein calculating the distance between the first external graphs of the two first clustering groups as the between-class distance between the two first clustering groups comprises:
determining a second external graph enclosing the first external graphs of the two first clustering groups; and
calculating the distance between the first external graphs of the two first clustering groups according to sizes of the first external graphs of the two first clustering groups and a size of the second external graph.

4. The method as claimed in claim 3, wherein calculating the distance between the first external graphs of the two first clustering groups according to the sizes of the first external graphs of the two first clustering groups and the size of the second external graph comprises:
calculating a difference value between the size of the second external graph and the size of a large-size first external graph as the distance between the first external graphs of the two first clustering groups, wherein the large-size first external graph is a first external graph with a large size in the first external graphs of the two first clustering groups.

5. The method as claimed in claim 3, wherein the method further comprises:
determining whether the size of the second external graph is greater than a preset size threshold value;
in response to determining that the size of the second external graph is greater than the preset size threshold value, determining the distance between the first external graphs of the two first clustering groups to be a preset maximum value, the preset maximum value being greater than the calculated distance between the first external graphs of any two first clustering groups; and
in response to determining that the size of the second external graph is not greater than the preset size threshold value, performing the step of calculating the distance between the first external graphs of the two first clustering groups according to the sizes of the first external graphs of the two first clustering groups and the size of the second external graph.

6. The method as claimed in claim 1, wherein the spatial points to-be-processed are positions at which any objects are located, and different spatial points to-be-processed are positions at which objects of a same type are located, or positions at which objects of different types are located.

7. The method as claimed in claim 1, the first external graph of the first clustering group is a smallest rectangle enclosing all the spatial points to-be-processed in the first clustering group.

8. The method as claimed in claim 3, wherein calculating the distance between the first external graphs of the two first clustering groups according to the sizes of the first external graphs of the two first clustering groups and the size of the second external graph comprises:
subtracting the sizes of the first external graph of the two first clustering groups from the size of the second external graph to obtain the distance between the first external graphs of the two first clustering groups.

9. The method as claimed in claim 3, wherein calculating the distance between the first external graphs of the two first clustering groups according to the sizes of the first external graphs of the two first clustering groups and the size of the second external graph comprises:
calculating a difference value between the size of the second external graph and the size of the small-size first external graph as the distance between the first external graphs of the two first clustering groups, wherein the small-size first external graph is the first external graph with a small size in the first external graphs of the two first clustering groups.

10. The method as claimed in claim 5, wherein the size of the second external graph is greater than the preset size threshold value comprises one of the followings:
the horizontal span of the second external graph is greater than a preset horizontal span threshold value and the longitudinal span of the second external graph is greater than a preset longitudinal span threshold value;
the horizontal span of the second external graph is greater than a preset horizontal span threshold value; and
the longitudinal span of the second external graph is greater than a preset longitudinal span threshold value.

11. An electronic device, comprising:
at least one processor, and
a memory, in communication connection with the at least one processor, wherein
the memory is configured to store instructions capable of being performed by the at least one processor, and the instructions are performed by the at least one processor to perform the following steps:
clustering a plurality of spatial points to-be-processed according to distances between the plurality of spatial points to-be-processed to obtain a plurality of first clustering groups;
for each first clustering group, determining a first external graph enclosing all the spatial points to-be-processed in this first clustering group; and
merging the plurality of first clustering groups according to distances between first external graphs of the plurality of first clustering groups to obtain at least one second clustering group.

12. The electronic device as claimed in claim 11, wherein merging the plurality of first clustering groups according to the distances between the first external graphs of the plurality of first clustering groups to obtain the at least one second clustering group comprises:
for every two first clustering groups, calculating distances between the first external graphs of the two first clustering groups as a between-class distance between the two first clustering groups; and
merging the plurality of first clustering groups according to the between-class distance between the two first clustering groups to obtain the at least one second clustering group.

13. The electronic device as claimed in claim 12, wherein calculating the distance between the first external graphs of the two first clustering groups as the between-class distance between the two first clustering groups comprises:
determining a second external graph enclosing the first external graphs of the two first clustering groups; and
calculating the distance between the first external graphs of the two first clustering groups according to sizes of the first external graphs of the two first clustering groups and a size of the second external graph.

14. The electronic device as claimed in claim 13, wherein calculating the distance between the first external graphs of the two first clustering groups according to the sizes of the first external graphs of the two first clustering groups and the size of the second external graph comprises:
calculating a difference value between the size of the second external graph and the size of a large-size first external graph as the distance between the first external graphs of the two first clustering groups, wherein the large-size first external graph is a first external graph with a large size in the first external graphs of the two first clustering groups.

15. The electronic device as claimed in claim 13, wherein the method further comprises:
determining whether the size of the second external graph is greater than a preset size threshold value;
in response to determining that the size of the second external graph is greater than the preset size threshold value, determining the distance between the first external graphs of the two first clustering groups to be a preset maximum value, the preset maximum value being greater than the calculated distance between the first external graphs of any two first clustering groups; and
in response to determining that the size of the second external graph is not greater than the preset size threshold value, performing the step of calculating the distance between the first external graphs of the two first clustering groups according to the sizes of the first external graphs of the two first clustering groups and the size of the second external graph.

16. A non-transitory storage medium, storing computer instructions, wherein the computer instructions are used for performing, by a computer, the following steps:
clustering a plurality of spatial points to-be-processed according to distances between the plurality of spatial points to-be-processed to obtain a plurality of first clustering groups;
for each first clustering group, determining a first external graph enclosing all the spatial points to-be-processed in this first clustering group; and
merging the plurality of first clustering groups according to distances between first external graphs of the plurality of first clustering groups to obtain at least one second clustering group.

17. The non-transitory storage medium as claimed in claim 16, wherein merging the plurality of first clustering groups according to the distances between the first external graphs of the plurality of first clustering groups to obtain the at least one second clustering group comprises:
for every two first clustering groups, calculating distances between the first external graphs of the two first clustering groups as a between-class distance between the two first clustering groups; and
merging the plurality of first clustering groups according to the between-class distance between the two first clustering groups to obtain the at least one second clustering group.

18. The non-transitory storage medium as claimed in claim 17, wherein calculating the distance between the first external graphs of the two first clustering groups as the between-class distance between the two first clustering groups comprises:
determining a second external graph enclosing the first external graphs of the two first clustering groups; and
calculating the distance between the first external graphs of the two first clustering groups according to sizes of the first external graphs of the two first clustering groups and a size of the second external graph.

19. The non-transitory storage medium as claimed in claim 18, wherein calculating the distance between the first external graphs of the two first clustering groups according to the sizes of the first external graphs of the two first clustering groups and the size of the second external graph comprises:
calculating a difference value between the size of the second external graph and the size of a large-size first external graph as the distance between the first external graphs of the two first clustering groups, wherein the large-size first external graph is a first external graph with a large size in the first external graphs of the two first clustering groups.

20. The non-transitory storage medium as claimed in claim 18, wherein the method further comprises:
determining whether the size of the second external graph is greater than a preset size threshold value;
in response to determining that the size of the second external graph is greater than the preset size threshold value, determining the distance between the first external graphs of the two first clustering groups to be a preset maximum value, the preset maximum value being greater than the calculated distance between the first external graphs of any two first clustering groups; and
in response to determining that the size of the second external graph is not greater than the preset size threshold value, performing the step of calculating the distance between the first external graphs of the two first clustering groups according to the sizes of the first external graphs of the two first clustering groups and the size of the second external graph.
